(19) United States
(12) Patent Application Publication
(10) Pub. No.: US 2014/0379404 A1
(43) Pub. Date: Dec. 25, 2014

(54) LOCATION TRIGGERED SCHEDULING

(71) Applicant: INTERNATIONAL BUSINESS MACHINES CORPORATION, Armonk, NY (US)

(72) Inventors: Paul R. Bastide, Boxford, MA (US); Matthew E. Broomhall, Goffstown, NH (US); Ralph E. LeBlanc, JR., Pepperell, MA (US); Robert E. Loredo, North Miami Beach, FL (US); Fang Lu, Billerica, MA (US); Alaa Abou Mahmoud, Dracut, MA (US)

(21) Appl. No.: 13/926,598

(22) Filed: Jun. 25, 2013

(51) Int. Cl. G06Q 10/10

(52) U.S. Cl. CPC G06Q 10/1095
USPC 705/7.19

(57) ABSTRACT

Mechanisms for facilitating in-person meetings are provided. Such mechanisms may comprise: identifying a set of participants for a meeting according to one or more scheduling criterion; utilizing location information associated with the set of participants; and scheduling an in-person (face-to-face) meeting with at least two members of the set of participants.

### BACKGROUND

The present disclosure relates generally to location triggered scheduling.

As meetings are increasingly moving to online and digital forms, there is a dimension of the meeting which is lost: the person-to-person interaction. This is a valuable and often overlooked component to successful meetings.

Examples of such a lost component to successful meetings include the following: (a) In the same building two employees are scheduled to meet. Rather than find a room to meet, the employees dial in through teleconference, and work through their issues on the phone; (b) People may work from home frequently, and choose to schedule meetings semi-regularly, when they arrive at the office. Such meetings nevertheless typically occur over the phone; even when a majority of the participants are local to the scheduler; (c) There is a common practice for travel between offices. For example, a sales person may go to visit a potential customer who is near a company office to which the sales person also travels. However, meetings between the sales person and the customer as well as between the sales person and other company employees may be difficult to coordinate.

### SUMMARY

In various embodiments, methodologies may be provided that automatically provide location triggered scheduling.

In one embodiment, a method for scheduling an in-person meeting is provided, the method comprising: determining, by a processor, an existence of a scheduled remote meeting having a set of scheduled remote participants; obtaining, by the processor, location information associated with each of the scheduled remote participants; determining, by the processor, that at least two of the scheduled remote participants will be or are in the same location at a given time; and re-scheduling, by the processor, the scheduled remote meeting to facilitate an in-person meeting with the at least two of the scheduled remote participants who will be or are in the same location at the given time.

In another embodiment, a method for scheduling an in-person meeting is provided, the method comprising: determining at a first point in time, by a processor, an existence of a proposed meeting having a set of proposed participants, wherein the proposed meeting had been scheduled prior to the first point in time for a proposed meeting time subsequent to the first point in time; obtaining at point in time subsequent to the first point in time, by the processor, location information associated with each of the proposed participants; determining, by the processor, based upon the location information, that at least two of the proposed participants will be or are in the same location at a given time; and scheduling, with the processor, an in-person meeting with the at least two of the proposed participants who will be or are in the same location at the given time.

In another embodiment, a computer readable storage medium, tangibly embodying a program of instructions executable by the computer for scheduling an in-person meeting is provided, the program of instructions, when executing, performing a method comprising: determining an existence of a scheduled remote meeting having a set of scheduled remote participants; obtaining location information associated with each of the scheduled remote participants; determining that at least two of the scheduled remote participants will be or are in the same location at a given time; and re-scheduling the scheduled remote meeting to facilitate an in-person meeting with the at least two of the scheduled remote participants who will be or are in the same location at the given time.

### BRIEF DESCRIPTION OF THE DRAWINGS

Various objects, features and advantages of the present invention will become apparent to one skilled in the art, in view of the following detailed description taken in combination with the attached drawings, in which:

FIG. 1 depicts a block diagram of a system according to one embodiment of the present invention;

FIG. 2 depicts a flowchart of a method according to one embodiment of the present invention;

FIG. 3 depicts a block diagram of a system according to one embodiment of the present invention;

FIG. 4 depicts a flowchart of a method according to one embodiment of the present invention;

FIG. 5 depicts a block diagram of a system according to one embodiment of the present invention; and

FIG. 6 depicts a block diagram of a system according to one embodiment of the present invention.

### DETAILED DESCRIPTION

In one example, one or more systems may provide for location triggered scheduling. In another example, one or more methods may provide for location triggered scheduling. In another example, one or more algorithms may provide for location triggered scheduling.

As described herein, mechanisms for facilitating in-person meetings are provided. Such mechanisms may comprise: identifying a set of participants for a meeting according to one or more scheduling criterion (e.g., a desire by one person to have a meeting with one or more other people); utilizing location information associated with the set of participants; and scheduling an in-person (face-to-face) meeting with at least two members of the set of participants.

In one example, the location information comprises individual physical location information for each of the members of the set of participants.

In another example, the location information is received from sensor information selected from a group including (but not limited to): information from a badge reader (e.g., an automated door entry system), information from a global positioning system (GPS), information from a sign-on (e.g., a network sign-on, a website sign-on), information from an Internet Protocol (IP) address, information from a point of sale terminal (e.g., a cash register), information from a cell phone, information from an electronic check-in service (e.g., a web-based check-in service), information from a credit card usage and/or information from a debit card usage.

In another example, the location information is received from planning information (e.g., information from an electronic calendar).

In another example, mechanisms are provided for rescheduling a given meeting (e.g., to fit an alternative time).

In another example, mechanisms are provided for applying one or more prioritizing criterion for scheduling (and/or rescheduling) a meeting. In one specific example, the one or more prioritizing criterion may be selected from a group including (but not limited to): meeting time, meeting order, meeting type, meeting style, queue of meetings, available resources, meeting and/or participant hierarchy, meeting and/or participant priority, meeting and/or participant requirements, meeting frequency, number of in-person participants exceeding a threshold and/or a business purpose.

In another example, mechanisms are provided for sending a notification to each scheduled meeting participant. In one specific example, each notification may relate to an originally scheduled meeting. In another specific example, each notification may relate to a re-scheduled meeting. In another specific example, each notification may be selected from a group including (but not limited to): email, phone, mail, Short Message Service (SMS) and/or electronic calendar entry.

In the present disclosure the term “electronic calendar service” (or “electronic calendar service subsystem”) refers to a computerized or automated mechanism that has the capability of originating, accepting, arranging, organizing, tracking, scheduling and/or displaying one or more meetings (and/or proposed meetings) for users thereof.

In the present disclosure the term “remote meeting” refers to a meeting carried out in any manner such that at least two of the participants are at different physical locations (e.g., different rooms, different offices, different towns, different states, different countries). In one example, a remote meeting may be carried out via telephone. In another example, a remote meeting may be carried out via video conference. In another example, a remote meeting may be carried out via web conference.

In the present disclosure the term “in-person meeting” refers to a meeting carried out in any manner such that at least two of the participants meet “face to face” at the same physical location (e.g., the same room).

In the present disclosure the term “time” refers to one or more clock times (e.g., “1:30 PM” or “from 10:00 AM to 3:00 PM”), one or more days (e.g., “Monday” or “Thursday through Saturday”), one or more months (e.g., “January” or “March and April”), one or more dates (e.g., “Jan. 1, 2013” or “Feb. 1, 2013 to Feb. 10, 2013”) or any combination thereof.

As described herein, mechanisms are provided for facilitating/enabling in-person (face-to-face) meetings which may otherwise occur through a remote means (e.g., phone, video conference, web conference). Each in-person meeting may be scheduled by utilizing location information of a set of potential meeting participants. In one specific example, the location information may be selected from the group including (but not limited to): (a) sensor (e.g., GPS information); (b) calendar information; and/or (c) travel information.

As described herein, mechanisms are provided for: (a) queuing up one or more future desired events for scheduling; and/or (b) re-scheduling one or more currently scheduled future events.

In one specific example, the queuing up may continue until the time/location criteria of at least two people are matched (e.g., until an opportunity meet at a given future time at a given location is determined).

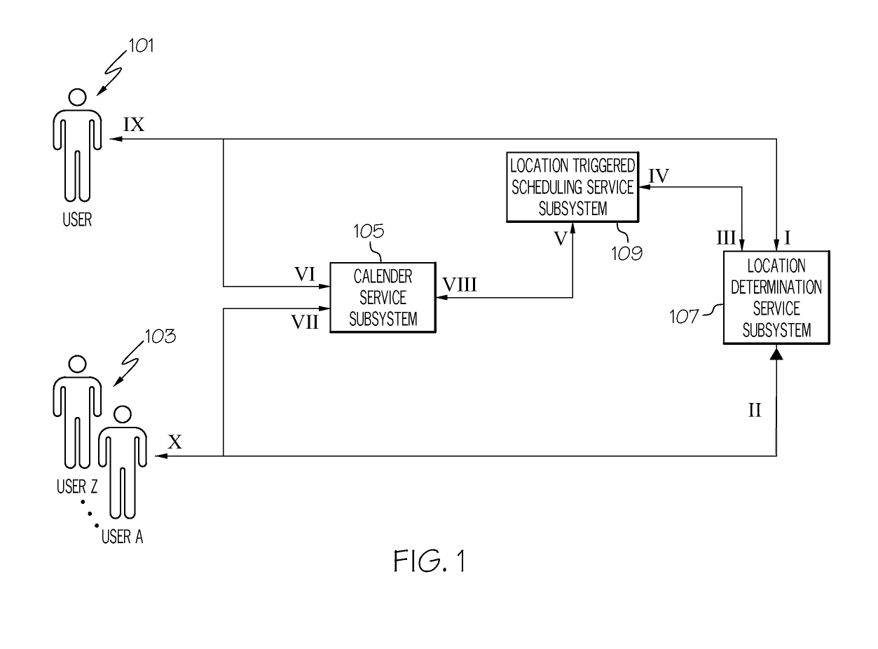

Referring now to FIG. 1, an example implementation according to one embodiment is depicted. In this example, there are: User—the primary participant (shown at call out number 101); UserA . . . UserZ—the other participants (shown collectively at call out number 103); Calendar Service Subsystem (shown at call out number 105); Location Determination Service Subsystem (shown at call out number 107); and Location Triggered Scheduling Service Subsystem (shown at call out number 109). As described in more detail below, the Calendar Service Subsystem 105 provides calendar services including meeting and availability management; the Location Determination Service Subsystem 107 provides location based services including determining the location of each of the users; and the Location Triggered Scheduling Service Subsystem 109 provides an interface between the Calendar Service Subsystem 105 and the Location Determination Service Subsystem 107 to schedule and/or reschedule meeting(s) for the users based upon user location.

Of course, while “other participants” are identified as UserA . . . UserZ, any desired number of participants may be involved.

Still referring to FIG. 1, it is seen that this embodiment may operate, in general to provide a Location Triggered Calendaring Use Case as follows: (I) User 101 checks-in to the Location Determination Service Subsystem 107 with location information (in various examples, the check-in may occur repeatedly (e.g., periodically) and/or at any time before a scheduled meeting); (II) UserA . . . UserZ 103 check-in to the Location Determination Service Subsystem 107 with location information (in various examples, each check-in may occur repeatedly (e.g., periodically) and/or at any time before a scheduled meeting); (III) Location Triggered Scheduling Service Subsystem 109 requests updated location information from Location Determination Service Subsystem 107; (IV) Location Triggered Scheduling Service Subsystem 109 receives updated location information from Location Determination Service Subsystem 107; (V) Location Triggered Scheduling Service Subsystem 109 retrieves current meeting information from Calendar Service Subsystem 105 (this information may have been previously stored (VI and VII) in the Calendar Service Subsystem 105 by one or more of the users (in one specific example, User 101 may make a request and UserA . . . UserZ 103 may participate)); (VIII) Location Triggered Scheduling Service Subsystem 109 schedules/reschedules with the Calendar Service Subsystem 105 any meeting where at least two of the users are (or will be) available at the same location and the same time; (IX and X) Calendar Service Subsystem 105 notifies the users of the scheduled/re-scheduled in-person meeting.

In one specific example, one or more of the users may be empowered to select or reject a scheduled/re-scheduled in-person meeting. In another specific example, if a meeting is rejected one or more users may be notified of the rejection and the process could iterate until an agreed time is found.

Referring now more specifically to Location Determination Service Subsystem 107 of FIG. 1, the location of each user may be obtained as follows: (a) via one or more check-in services (e.g., web-based check-in service); (b) via Instant Messaging sign-on and registration of the location at the applicable IP Address; (c) via mobile network positioning (e.g., edge network positioning); (d) via Global Positioning System (GPS)—which provides a service to track a user's physical location; and/or (e) via travel plans or other location information (e.g., as recorded in one or more electronic calendar meeting invites/acceptances or personal reminders).

In one specific example, the Location Determination Service Subsystem 107 may determine schedule patterns (e.g., work schedule patterns) of users (e.g., to determine current location(s) and/or future location(s) of users). Such determination may be made, for example, by analyzing badge reader usage, cash register usage, cell phone usage; credit card usage; and/or debit card usage.

In another specific example, the Location Determination Service Subsystem 107 may use an ensemble method to determine current and/or future locations (e.g., a vote between different location based services may be used to get better get precision of a person's location.).

In another specific example, the Location Determination Service Subsystem 107 may utilize any desired configurable level of granularity (e.g., address, site, building, floor) with regard to determining current location(s) and/or future location(s).

Referring now more specifically to Location Triggered Scheduling Service Subsystem 109 of FIG. 1, this subsystem may, upon receiving the location information for each of the meeting participants (e.g., proposed and/or scheduled participants), perform the following: (a) check to see if a given threshold (e.g., a majority or more than half) of the meeting participants will be or are in the same location; (b) determines the length of the scheduled meeting; (c) determines if a new (or replacement) in-person meeting can fit in a new (or an alternative) time slot (for at least the threshold number of participants); validates (for at least the threshold number of participants) the new (or alternative) time slot via the Calendar Service Subsystem; and (e) sends a schedule (or a re-schedule) notification (e.g., to the set of the participants who will be or are in the same location).

In one specific example, meetings may be processed in serial order of time (e.g., a meeting scheduled for one day from now is prioritized over a meeting scheduled for two days from now).

In another specific example, optimization may be applied to improve performance of scheduling (e.g., to bunch the analysis and/or prioritize certain styles of meetings (such as one-on-one, team, divisional)).

In another specific example, the scheduling/re-scheduling may utilize a double blind procedure (that is, a check with each participant before scheduling/re-scheduling may occur) as a precursor to the actual setting/changing of meeting time/place. In one specific example, check before scheduling/re-scheduling based on common locations now or in future.

In another specific example, notification (e.g., to the set of the participants who will be or are in the same location) may be made via phone, mail, email, SMS.

In another specific example, notification (e.g., to the set of the participants who will be or are in the same location) may be made to a given person via a preferred communication mechanism (e.g., based on the proximity of the meeting location/time).

In another specific example, notification (e.g., to the set of the participants who will be or are in the same location) may be made indicating the location of each person in the meeting (this notification may be, for example, graphical and/or textual and may use GPS information).

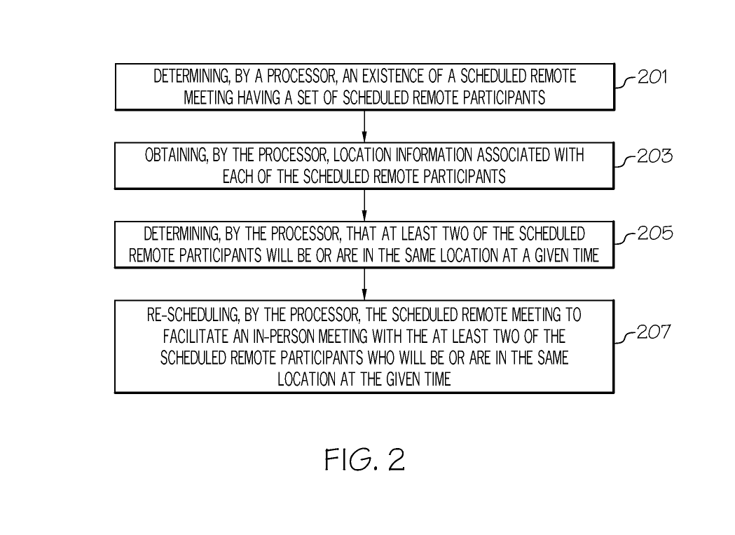

Referring now to FIG. 2, a method for scheduling an in-person meeting is shown. As seen in this FIG. 2, the method of this embodiment comprises: at 201—determining, by a processor, an existence of a scheduled remote meeting having a set of scheduled remote participants; at 203—obtaining, by the processor, location information associated with each of the scheduled remote participants; at 205—determining, by the processor, that at least two of the scheduled remote participants will be or are in the same location at a given time; and at 207—re-scheduling, by the processor, the scheduled remote meeting to facilitate an in-person meeting with the at least two of the scheduled remote participants who will be or are in the same location at the given time.

In one example, the determining the existence of the scheduled remote meeting comprises receiving information indicative of the existence of the scheduled remote meeting from an electronic calendar system.

In another example, the obtaining location information associated with each of the scheduled remote participants comprises obtaining at least one of: (a) a current location of each of the scheduled remote participants; (b) a future location of each of the scheduled remote participants; or (c) any combination thereof.

In another example, the location information comprises at least one of: (a) information from a badge reader; (b) information from a GPS; (c) information from a network sign-on; (d) information from a website sign-on; (e) information from an IP address; (f) information from a point of sale terminal; (g) information from a cell phone; (h) information from an electronic check-in service; (i) information from a credit card usage; (j) information from a debit card usage; or (k) any combination thereof.

In another example, the method further comprises determining, for the scheduled remote meeting, at least one of: (a) a time of the scheduled remote meeting; (b) a length of the scheduled remote meeting; (c) an identification of each of the scheduled remote participants in the scheduled remote meeting; or (d) any combination thereof.

In another example, the determining that at least two of the scheduled remote participants will be or are in the same location at the given time comprises determining at least one of: (a) a time that the scheduled remote participants will be or are in the same location; (b) a length of stay that the scheduled remote participants will be or are in the same location; or (c) any combination thereof.

In another example, the method comprises determining, by the processor, a number of the scheduled remote participants who will be or are in the same location at the given time.

In another example, the re-scheduling the scheduled remote meeting to facilitate the in-person meeting with the at least two of the scheduled remote participants who will be or are in the same location at the given time is performed only after it has been determined that the number of the scheduled remote participants who will be or are in the same location at the given time is above a given threshold.

In another example, the re-scheduling comprises cancelling the scheduled remote meeting and replacing the cancelled meeting with a replacement in-person meeting at a different time than the cancelled meeting was scheduled.

In another example, the re-scheduling comprises sending, to an electronic calendar system, information indicative of the in-person meeting.

In another example, the information indicative of the in-person meeting comprises at least one of: (a) a time of the in-person meeting; (b) a list of scheduled attendees to the in-person meeting; or (c) any combination thereof.

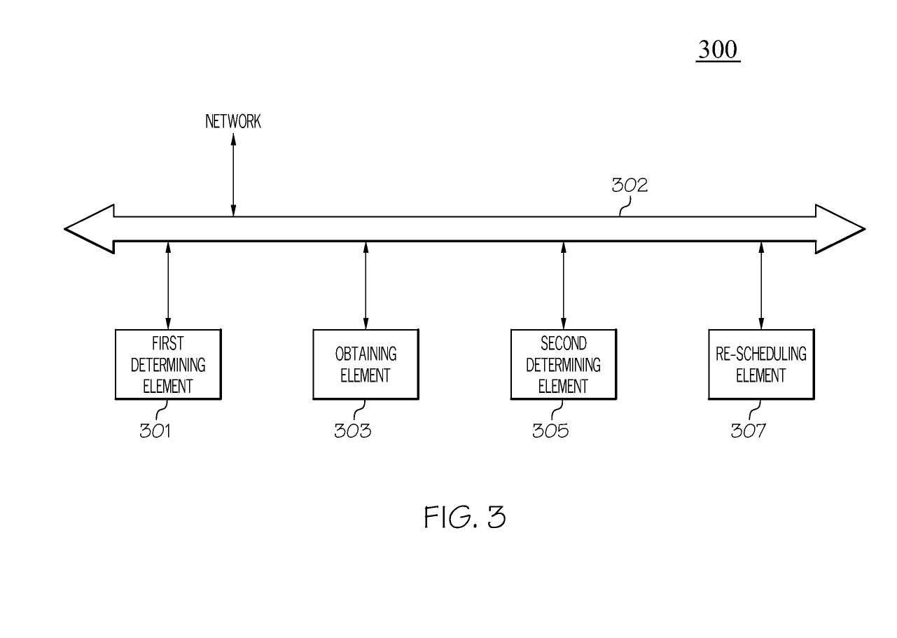

Referring now to FIG. 3, in another embodiment, a system 300 for scheduling an in-person meeting is provided. This system may include the following elements: a first determining element 301 configured to determine an existence of a scheduled remote meeting having a set of scheduled remote participants; an obtaining element 303 configured to obtain location information associated with each of the scheduled remote participants; a second determining element 305 configured to determine that at least two of the scheduled remote participants will be or are in the same location at a given time; and a re-scheduling element 307 configured to re-schedule the scheduled remote meeting to facilitate an in-person meeting with the at least two of the scheduled remote participants who will be or are in the same location at the given time.

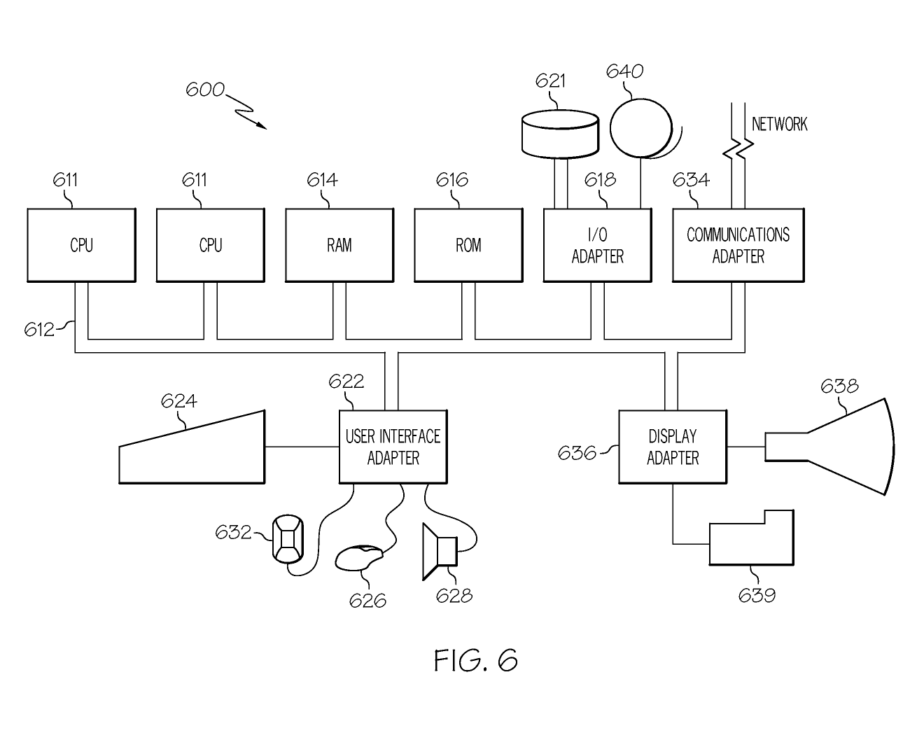

In one example, communication between and among the various elements of FIG. 3 may be bi-directional. In another example, the communication may be carried out via bus 302. In another example, communication may be carried out via the Internet, an intranet, a local area network, a wide area network and/or any other desired communication channel(s). In another example, each of the elements may be operatively connected to each of the other elements. In another example, some or all of these elements may be implemented in a computer system of the type shown in FIG. 6.

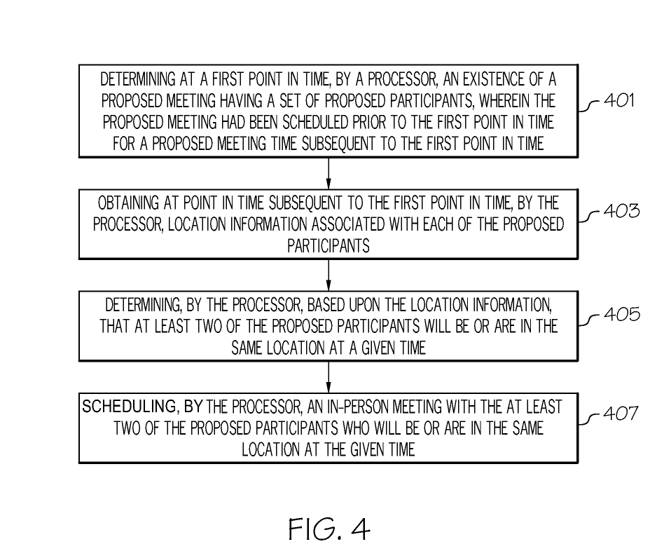

Referring now to FIG. 4, a method for scheduling an in-person meeting is shown. As seen in this FIG. 4, the method of this embodiment comprises: at 401—determining at a first point in time, by a processor, an existence of a proposed meeting having a set of proposed participants, wherein the proposed meeting had been scheduled prior to the first point in time for a proposed meeting time subsequent to the first point in time; at 403—obtaining at point in time subsequent to the first point in time, by the processor, location information associated with each of the proposed participants; at 405—determining, by the processor, based upon the location information, that at least two of the proposed participants will be or are in the same location at a given time; and at 407—scheduling, with the processor, an in-person meeting with the at least two of the proposed participants who will be or are in the same location at the given time.

In one example, the obtaining the location information and the determining, based upon the location information, that at least two of the proposed participants will be or are in the same location at the given time, are performed periodically.

In another example, the scheduling the in-person meeting with the at least two of the proposed participants who will be or are in the same location at the given time is performed after at least two cycles of the obtaining the location information and the determining, based upon the location information, that at least two of the proposed participants will be or are in the same location at the given time, have been completed.

In another example, the determining the existence of the proposed meeting comprises receiving information indicative of the existence of the proposed meeting from an electronic calendar system.

In another example, the obtaining location information associated with each of the proposed participants comprises obtaining at least one of: (a) a current location of each of the proposed participants; (b) a future location of each of the proposed participants; or (c) any combination thereof.

In another example, the location information comprises at least one of: (a) information from a badge reader; (b) information from a GPS; (c) information from a network sign-on; (d) information from a website sign-on; (e) information from an IP address; (f) information from a point of sale terminal; (g) information from a cell phone; (h) information from an electronic check-in service; (i) information from a credit card usage; (j) information from a debit card usage; or (k) any combination thereof.

In another example, the method further comprises determining, for the proposed meeting, at least one of: (a) a time of the proposed meeting; (b) a length of the proposed meeting; (c) an identification of each of the proposed participants in the proposed meeting; or (d) any combination thereof.

In another example, the determining that at least two of the proposed participants will be or are in the same location at the given time comprises determining at least one of: (a) a time that the proposed participants will be or are in the same location; (b) a length of stay that the proposed participants will be or are in the same location; or (c) any combination thereof.

In another example, the method further comprises determining, by the processor, a number of the proposed participants who will be or are in the same location at the given time.

In another example, the scheduling the in-person meeting with the at least two of the proposed participants who will be or are in the same location at the given time is performed only after it has been determined that the number of the proposed participants who will be or are in the same location at the given time is above a given threshold.

In another example, the scheduling comprises sending, to an electronic calendar system, information indicative of the in-person meeting.

In another example, the information indicative of the in-person meeting comprises at least one of: (a) a time of the in-person meeting; (b) a list of scheduled attendees to the in-person meeting; or (c) any combination thereof.

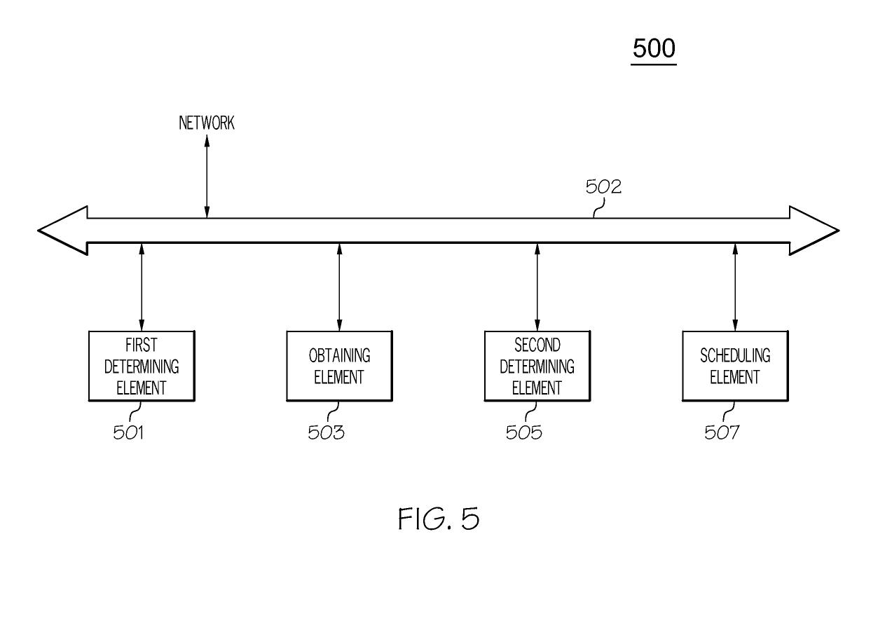

Referring now to FIG. 5, in another embodiment, a system 500 for scheduling an in-person meeting is provided. This system may include the following elements: a first determining element 501 configured to determine at a first point in time an existence of a proposed meeting having a set of proposed participants, wherein the proposed meeting had been scheduled prior to the first point in time for a proposed meeting time subsequent to the first point in time; an obtaining 503 configured to obtain at point in time subsequent to the first point in time location information associated with each of the proposed participants; a second determining element 505 configured to determine based upon the location information, that at least two of the proposed participants will be or are in the same location at a given time; and a scheduling element 507 configured to schedule an in-person meeting with the at least two of the proposed participants who will be or are in the same location at the given time.

In one example, communication between and among the various elements of FIG. 5 may be bi-directional. In another example, the communication may be carried out via bus 502. In another example, communication may be carried out via the Internet, an intranet, a local area network, a wide area network and/or any other desired communication channel(s). In another example, each of the elements may be operatively connected to each of the other elements. In another example, some or all of these elements may be implemented in a computer system of the type shown in FIG. 6.

Referring now to FIG. 6, this figure shows a hardware configuration of computing system 600 according to an embodiment of the present invention. As seen, this hardware configuration has at least one processor or central processing unit (CPU) 611. The CPUs 611 are interconnected via a system bus 612 to a random access memory (RAM) 614, read-only memory (ROM) 616, input/output (I/O) adapter 618 (for connecting peripheral devices such as disk units 621 and tape drives 640 to the bus 612), user interface adapter 622 (for connecting a keyboard 624, mouse 626, speaker 628, microphone 632, and/or other user interface device to the bus 612), a communications adapter 634 for connecting the system 600 to a data processing network, the Internet, an Intranet, a local area network (LAN), etc., and a display adapter 636 for connecting the bus 612 to a display device 638 and/or printer 639 (e.g., a digital printer or the like).

In other examples, any steps described herein may be carried out in any appropriate desired order.

As described herein, the scheduling of an in-person meeting may comprise: (a) determining an existence of a scheduled future remote meeting having a set of potential participants (including determining the time, date and length of the future remote meeting as well as an identification of each of the potential meeting participants); (b) obtaining current and/or future physical location information for each of the potential participants; (c) determining a number of the potential participants that are in the same physical location at a given time (including determining the time and length of stay of each of the potential participants at each physical location); and (d) re-scheduling the scheduled future remote meeting to an alternative date/time to facilitate at least one in-person meeting with at least two members of the set of participants.

As described herein, mechanisms are provided for: (a) queuing up one or more future desired events for scheduling; and/or (b) re-scheduling one or more currently scheduled future events.

In one specific example, the queuing up may continue until the time/location criteria of at least two people are matched (e.g., until an opportunity meet at a given future time at a given location is determined).

As described herein, various embodiments operate in a context where one or more users are dynamic with respect to each of their physical locations (e.g., each of their physical locations at a current time and each of their physical locations at one or more future times).

In one example, scheduling and/or re-scheduling may be triggered on demand (e.g., when a location changes).

In another example, scheduling and/or re-scheduling may be triggered periodically (e.g., overnight when travel or plans that are updated on a calendar are matched for meeting scheduling).

In another example, various embodiments may be provided in the context of: Cloud: Delivery model: Software as a Service (SaaS); Cloud: Deployment model: Private; Cloud: Deployment model: Public; Cloud: Enabling technology: Interfaces (application, user); Converged Communications: Location Based Services (LBS); and/or Software: Collaborative applications.

As described herein, various embodiments provide an intelligent and flexible system which enables in-person meetings (in one specific example, a mechanism may be provided to take advantage of current and/or predicted traffic pattern (e.g., automobile traffic patterns, air travel traffic patterns, rail travel traffic patterns) in order to schedule/re-schedule one or more meetings).

In another example, embodiments may be applied to coordinate an in-person meeting in the situation where joint travel provides a good opportunity to meet in-person.

In another example, embodiments may be applied to alleviate a “round robin” (back and forth, back and forth) type of scheduling problem and to aid in finding the optimal times to meet in-person.

As described herein, location data may be analyzed to re-schedule a future remote meeting to enable multiple parties to instead meet in-person. Various advantages include (but are not limited to): (a) Increased Usability for the meeting participants; (b) Increased face-to-face meetings; and/or (c) Improved Collaboration.

As described herein, mechanisms may be provided to establish a queue of unrealized meetings which would be best served by in-person meetings. In one example, this queue may be weighted and prioritized. In another example, one or more existing hierarchy models may be used in order to override the scheduling of existing meetings.

In another example, mechanisms may be provided to enable opportunistic meetings (such as skip level type meetings; or a meeting which doesn't have to occur to keep business moving, but is nice to schedule based on opportunity to make in person connections). In one specific example, these may be scheduled based on a set of criteria and quota (e.g., attendance quota) which needs to reach a minimum goal over a time period based on predefined policies.

In another example, mechanisms may be provided to enable one or more watch lists (e.g., where keywords trigger meetings between double blinds). In one specific example, operation may be as follows: (a) User may establish a desire to meet with someone about Topic A (this desire may be evidenced, for example, as an a current or future intent (e.g., “meet by next June” or “meet in June”), wherein such intent is registered in a calendar system as an intent to schedule a proposed meeting; (b) UserA . . . UserZ may desire to meet about Topic A (this desire may also, for example, be registered in the calendar system); (c) System determines when parties are (or will be) in the same location and schedules/re-schedules an appropriate in-person meeting. In another specific example, a queue may exist which has names and subject of meetings instead of a full description.

In another example, mechanisms may be provided to utilize travel plans (e.g., future travel plans) to recommend a possible meeting time (e.g., in-person meeting time) between two or more individuals. In one specific example, the recommendation may be made by looking into the future a configurable distance (e.g., one day from now; one week from now; one month from now; etc).

In other examples, mechanisms may be provided to determine patterns of location and activity in order to proactively suggest meetings.

In another example, mechanisms may be provided to automatically find resources at the in-person meeting location (e.g., a room, a projector, a computer, etc.).

In another example, mechanisms may be provided to enable a feature that automatically attempts to schedule a meeting with certain people if they happen to be (or will be) in the same location.

As described herein, embodiments are provided for scheduling a meeting and/or re-rescheduling a meeting. For example, when User A wants to schedule a phone/online meeting with User B, the system recognizes that User B will be visiting the User A's premises next week and suggests to have an in-person meeting instead. In one specific example, scheduling/re-scheduling can be automatic (e.g., pursuant to a company policy that encourages face-to-face communication such that all meetings where the participants happen to be in the same location are forced to be in-person meetings).

In another example, mechanisms are provided to make a suggestion (e.g., to a meeting chairperson) that (even though at least some of the attendees are or will be in the same location) that they nevertheless still have a remote (e.g., online) meeting (e.g., for at least one of the attendees). This may be useful for situations which involve, for example, changed, old or stale travel plans.

In another example, mechanisms may be provided to automatically marshal secondary resources (such as online resources) for use at the same time as the in-person meeting.

In another example, mechanisms are provided to implement a policy feature, administration feature, security feature and/or privacy feature which control the use of and/or access to the meeting scheduling/re-scheduling mechanisms.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any programming language or any combination of one or more programming languages, including an object oriented programming language such as Java, Smalltalk, C++ or the like or a procedural programming language, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention may be described herein with reference to flowchart illustrations and/or block diagrams of methods, systems and/or computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus or other devices provide processes for implementing the functions/acts specified in the flowchart and/or block diagram block or blocks.

The flowcharts and block diagrams in the figures illustrate the architecture, functionality, and operation of possible implementations of systems, methods and computer program products according to various embodiments of the present invention. In this regard, each block in the flowcharts or block diagrams may represent a module, segment, or portion of code, which comprises one or more executable instructions for implementing the specified logical function(s). It should also be noted that, in some implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustrations, and combinations of blocks in the block diagrams and/or flowchart illustrations, can be implemented by special purpose hardware-based systems that perform the specified functions or acts, or combinations of special purpose hardware and computer instructions.

It is noted that the foregoing has outlined some of the objects and embodiments of the present invention. This invention may be used for many applications. Thus, although the description is made for particular arrangements and methods, the intent and concept of the invention is suitable and applicable to other arrangements and applications. It will be clear to those skilled in the art that modifications to the disclosed embodiments can be effected without departing from the spirit and scope of the invention. The described embodiments ought to be construed to be merely illustrative of some of the features and applications of the invention. Other beneficial results can be realized by applying the disclosed invention in a different manner or modifying the invention in ways known to those familiar with the art. In addition, all of the examples disclosed herein are intended to be illustrative, and not restrictive.

What is claimed is:

1. A method for scheduling an in-person meeting, the method comprising:
determining, by a processor, an existence of a scheduled remote meeting having a set of scheduled remote participants;
obtaining, by the processor, location information associated with each of the scheduled remote participants;
determining, by the processor, that at least two of the scheduled remote participants will be or are in the same location at a given time; and
re-scheduling, by the processor, the scheduled remote meeting to facilitate an in-person meeting with the at least two of the scheduled remote participants who will be or are in the same location at the given time.

2. The method of claim 1, wherein the determining the existence of the scheduled remote meeting comprises receiving information indicative of the existence of the scheduled remote meeting from an electronic calendar system.

3. The method of claim 1, wherein the obtaining location information associated with each of the scheduled remote participants comprises obtaining at least one of: (a) a current location of each of the scheduled remote participants; (b) a future location of each of the scheduled remote participants; or (c) any combination thereof.

4. The method of claim 1, wherein the location information comprises at least one of: (a) information from a badge reader; (b) information from a GPS; (c) information from a network sign-on; (d) information from a website sign-on; (e) information from an IP address; (f) information from a point of sale terminal; (g) information from a cell phone; (h) information from an electronic check-in service; (i) information from a credit card usage; (j) information from a debit card usage; or (k) any combination thereof.

5. The method of claim 1, further comprising determining, for the scheduled remote meeting, at least one of: (a) a time of the scheduled remote meeting; (b) a length of the scheduled remote meeting; (c) an identification of each of the scheduled remote participants in the scheduled remote meeting; or (d) any combination thereof.

6. The method of claim 1, wherein the determining that at least two of the scheduled remote participants will be or are in the same location at the given time comprises determining at least one of: (a) a time that the scheduled remote participants will be or are in the same location; (b) a length of stay that the scheduled remote participants will be or are in the same location; or (c) any combination thereof.

7. The method of claim 1, further comprising determining, by the processor, a number of the scheduled remote participants who will be or are in the same location at the given time.

8. The method of claim 7, wherein the re-scheduling the scheduled remote meeting to facilitate the in-person meeting with the at least two of the scheduled remote participants who will be or are in the same location at the given time is performed only after it has been determined that the number of the scheduled remote participants who will be or are in the same location at the given time is above a given threshold.

9. The method of claim 1, wherein the re-scheduling comprises cancelling the scheduled remote meeting and replacing the cancelled meeting with a replacement in-person meeting at a different time than the cancelled meeting was scheduled.

10. The method of claim 1, wherein the re-scheduling comprises sending, to an electronic calendar system, information indicative of the in-person meeting.

11. The method of claim 10, wherein the information indicative of the in-person meeting comprises at least one of: (a) a time of the in-person meeting; (b) a list of scheduled attendees to the in-person meeting; or (c) any combination thereof.

12. A method for scheduling an in-person meeting, the method comprising:
determining at a first point in time, by a processor, an existence of a proposed meeting having a set of proposed participants, wherein the proposed meeting had been scheduled prior to the first point in time for a proposed meeting time subsequent to the first point in time;
obtaining at point in time subsequent to the first point in time, by the processor, location information associated with each of the proposed participants;
determining, by the processor, based upon the location information, that at least two of the proposed participants will be or are in the same location at a given time; and
scheduling, with the processor, an in-person meeting with the at least two of the proposed participants who will be or are in the same location at the given time.

13. The method of claim 12, wherein the obtaining the location information and the determining, based upon the location information, that at least two of the proposed participants will be or are in the same location at the given time, are performed periodically.

14. The method of claim 13, wherein the scheduling the in-person meeting with the at least two of the proposed participants who will be or are in the same location at the given time is performed after at least two cycles of the obtaining the location information and the determining, based upon the location information, that at least two of the proposed participants will be or are in the same location at the given time, have been completed.

15. The method of claim 12, wherein the determining the existence of the proposed meeting comprises receiving information indicative of the existence of the proposed meeting from an electronic calendar system.

16. The method of claim 12, wherein the obtaining location information associated with each of the proposed participants comprises obtaining at least one of: (a) a current location of each of the proposed participants; (b) a future location of each of the proposed participants; or (c) any combination thereof.

17. The method of claim 12, wherein the location information comprises at least one of: (a) information from a badge reader; (b) information from a GPS; (c) information from a network sign-on; (d) information from a website sign-on; (e) information from an IP address; (f) information from a point of sale terminal; (g) information from a cell phone; (h) information from an electronic check-in service; (i) information from a credit card usage; (j) information from a debit card usage; or (k) any combination thereof.

18. A computer readable storage medium, tangibly embodying a program of instructions executable by the computer for scheduling an in-person meeting, the program of instructions, when executing, performing a method comprising:
determining an existence of a scheduled remote meeting having a set of scheduled remote participants;
obtaining location information associated with each of the scheduled remote participants;
determining that at least two of the scheduled remote participants will be or are in the same location at a given time; and
re-scheduling the scheduled remote meeting to facilitate an in-person meeting with the at least two of the scheduled remote participants who will be or are in the same location at the given time.

19. The computer readable storage medium of claim 18, wherein the determining the existence of the scheduled remote meeting comprises receiving information indicative of the existence of the scheduled remote meeting from an electronic calendar system.

20. The computer readable storage medium of claim 18, wherein the obtaining location information associated with each of the scheduled remote participants comprises obtaining at least one of: (a) a current location of each of the scheduled remote participants; (b) a future location of each of the scheduled remote participants; or (c) any combination thereof.
